(19) United States
(12) Patent Application Publication
(10) Pub. No.: US 2015/0000338 A1
(43) Pub. Date: Jan. 1, 2015

(54) METHOD AND DEVICE FOR PRODUCING VACUUM TUBES FOR SOLAR THERMAL INSTALLATIONS

(71) Applicant: Dr.Laure Plasmatechnologie GmbH, Stuttgart (DE)

(72) Inventor: Stefan Laure, Stuttgart (DE)

(73) Assignee: DR. LAURE PLASMATECHNOLOGIE GMBH, Stuttgart (DE)

(21) Appl. No.: 14/367,314

(22) PCT Filed: Dec. 22, 2012
(86) PCT No.: PCT/DE2012/001222

§ 371 Date: Jun. 20, 2014

(30) Foreign Application Priority Data
Dec. 23, 2011 (DE) 10 2011 122 324.3

(51) Int. Cl. C03B 23/207; F24J 2/05; C03B 23/13; C03C 17/00; C03B 23/09

(52) U.S. Cl. CPC C03B 23/207; C03C 17/003; C03B 23/09; C03B 23/13; F24J 2/055; C03B 2225/00; C03C 2218/153
USPC 65/34; 65/153

(57) ABSTRACT

The invention relates to a method and to a device for producing vacuum tubes for solar thermal installations, wherein the vacuum tube comprises an outer tube and an inner tube arranged within the outer tube, and the gap between the outer tube and the inner tube is sealed with respect to the exterior and evacuated. An outer tube (4) is coated in a first vacuum unit (1) and an inner tube (5) is coated in a second vacuum unit (2). The coated outer tube (4) and the coated inner tube (5) are assembled in a third vacuum unit (3) and fused together at the ends. The third vacuum unit is connected to the first vacuum unit (1) and to the second vacuum unit (2), such that the outer tube (4) and the inner tube (5) are not exposed to the atmosphere throughout the entire production of the vacuum tubes.

The invention relates to a method and a device for producing vacuum tubes for solar thermal installations.

Such vacuum tubes are also referred to as tube collectors. They comprise an outer tube permeable to sunlight, also referred to as a cladding tube, and an inner tube, arranged within the outer tube, that is typically configured with an absorber. The outer tube and the inner tube are usually cylindrical tubes with a circular cross-section. In a preferred way the axes of the outer tube and inner tube run parallel to each other. The outer tube and inner tube can also be arranged coaxially. The outer tube and inner tube typically consist of glass. Applications in which an inner tube of metal is used are also known. The gap between the outer tube and the inner tube is sealed with respect to the exterior. A vacuum prevails in the gap. The pressure in the gap is well below atmospheric pressure. The particle density in the gap must be so small that no relevant transfer of heat from inner tube to outer tube and vice versa takes place other than radiation processes. The outer tubes and inner tubes used for the production of a vacuum tube are usually open at one end and closed at the other end. At the closed end the outer tube and inner tube each comprise a base. The outer tube and inner tube thus qualitatively have the appearance of a test tube. For the evacuation of the gap between the inner tube and the outer tube the gap is sealed at the open ends of the tubes. Evacuation is usually performed with the aid of a tubule that is arranged on the base of the outer tube. This tubule is connected to a vacuum pump. The medium is pumped out of the gap by means of the vacuum pump. The tubule is then fused and the gap is sealed with respect to all sides.

It is also possible in principle to produce vacuum tubes consisting of an outer tube open on both sides and an inner tube open on both sides. In this case the gap must be sealed at both ends of the inner tube and outer tube for evacuation.

For the production of a vacuum tube an outer tube and an inner tube are individually produced and provided with suitable coatings. The two tubes are then joined together and the gap is evacuated. Alternatively, the outer tube and the inner tube can be assembled in the vacuum. In both cases production takes place in a large number of individual manufacturing steps.

It has proven to be disadvantageous in vacuum tubes with a base on the outer tube and inner tube that the evacuation of the gap between outer tube and inner tube is difficult. Usually the outer tube and inner tube are joined together under atmospheric pressure. The diameter of the tubule for evacuation that is attached to the outer tube must on the one hand not be too great, as it is otherwise impossible to seal the gap. In particular, when the tubule is fused, liquefied gas can be sucked into the vacuum, which can lead to an enlargement of the transition area between the outer tube and the tubule and the destruction of the outer tube. If the diameter of the tubule is too small, the pumping times for evacuating the gap are very long. There is also the danger that the outer tube will not be sufficiently tight after the tubule has been fused in the area affected, so that air can penetrate the gap and the quality of the vacuum in the gap will suffer.

A further disadvantage is that the outer tube and inner tube must be heated up during the evacuation of the gap so that the substances that under atmospheric pressure adhere to the surfaces of the tubes detach and are removed during evacuation. It has further proven to be disadvantageous that the outer tube and the inner tube are exposed to different non-reproducible conditions owing to the individual manufacturing steps and the storage or transport taking place between the manufacturing steps. Moisture and dirt can gather. Although the tubes can be cleaned, in particular washed, before being joined together, this leads to increased moisture on the tubes, which is not desirable during joining. Since the production conditions are often not reproducible, a consistent quality cannot be achieved in the production of the vacuum tubes. Significant quality differences mean that the theoretical yield of vacuum tubes used in solar thermal installations is not reached in practice. Furthermore, production is cost and labour-intensive due to the large number of manufacturing steps.

The object of the invention is to provide a method and a device for producing vacuum tubes for solar thermal installations that allow vacuum tubes to be produced under reproducible conditions to a consistent quality and in the fewest possible manufacturing steps.

This object is achieved by a method having the features of claim 1 and by a device having the features of claim 17. The method is characterised in that the coating of the inner tube and the coating of the outer tube and the assembly of inner tube and outer tube take place in a vacuum in a closed system without the inner tube or outer tube being exposed to the atmosphere between the individual processing steps. To that end the outer tube is coated in a first vacuum unit. The inner tube is coated in a second vacuum unit. The first and the second vacuum unit are evacuated against atmospheric pressure throughout the processing. They are connected to a third vacuum unit. The third vacuum unit is connected to the first vacuum unit and the second vacuum unit such that the outer tube and inner tube are transported from the first and second vacuum unit into the third vacuum unit without coming into contact with the atmosphere. In a preferred way, the vacuum chamber of the first vacuum unit is separated from the vacuum chamber of the third vacuum unit only by a gate valve.

In the third vacuum unit the inner tube is introduced into the outer tube. Furthermore, in the third vacuum unit the gap between the inner tube and the outer tube is sealed. To that end, the free ends of the coated outer tube and of the coated inner tube are fused together. Furthermore, in the third vacuum unit the outer tube and inner tube are tempered, which brings about a targeted stress relief after the previous working steps.

Since the joining of the inner tube and outer tube takes place in the vacuum of the third vacuum unit, a vacuum also prevails in the gap between the outer tube and inner tube after sealing. If necessary, a getter can be introduced into the gap in order to bind the last traces of interfering or harmful substances through sorption or direct reaction.

Since the third vacuum unit is connected directly with the first vacuum unit, after coating the outer tube can be transported into the third vacuum unit without being exposed to the atmosphere. Likewise, after coating the inner tube can reach the third vacuum unit directly from the second vacuum unit without being exposed to the atmosphere, since the third vacuum unit is connected to the second vacuum unit.

Only the finished vacuum tube is discharged from the device and exposed to the atmosphere as the case may be.

The device according to the invention is configured with a first vacuum unit, a second vacuum unit and a third vacuum unit, each of which comprises several vacuum pumps for generating a vacuum. The first vacuum unit is connected to the third vacuum unit by means of a sealable opening. Likewise, the second vacuum unit is connected to the third vacuum unit by means of a sealable opening. The openings can be sealed with a gate valve as the case may be. A lock may also be provided between the vacuum units. The first and the second vacuum unit are each configured with at least one coating station in which a coating is applied to the outer tube and the inner tube respectively. The first vacuum unit is further configured with a first conveying device which conveys an outer tube in the first vacuum unit in the longitudinal direction of an outer tube. The second vacuum unit is configured with a second conveying device which conveys an inner tube in the second vacuum unit in the longitudinal direction of an inner tube. The conveying devices ensure that the outer tube and inner tube respectively are conveyed to the coating stations and the third vacuum unit. The third vacuum unit comprises a unit for joining an outer tube and an inner tube together. This may be part of a conveying device. Within it an inner tube and an outer tube are pushed into each other. The third vacuum unit is configured with a magazine in which a plurality of outer tubes and/or inner tubes is stored and tempered. The tempering is a heat treatment of outer tube and inner tube in order to obtain certain properties. In a preferred way the outer tube and inner tube consist of glass. Through the slow heating and/or cooling in tempering, stresses in the glass are eliminated. The third vacuum unit is configured with a fusing device which fuses the ends of an inner tube and an outer tube together in order to seal the gap between the outer tube and inner tube.

The first vacuum unit can be configured with a lock by means of which an outer tube is brought into the first vacuum unit. Furthermore, the second vacuum unit can be configured with a lock by means of which an inner tube is brought into the second vacuum unit. Finally, the third vacuum unit can be configured with a lock in order to discharge the finished vacuum tube from the third vacuum unit.

The method according to the invention and the device according to the invention can be used both to produce vacuum tubes sealed at one end and open at the other and to produce vacuum tubes open at both ends.

The method according to the invention and the device according to the invention have the advantage over known methods and devices that the coating of the outer tube and inner tube, the joining of the outer tube and inner tube and the sealing of the gap between the outer tube and inner tube take place in a vacuum in a closed system under defined and reproducible conditions. Since the outer tube and the inner tube are handled continuously in the vacuum throughout this process, no contamination and no moistening of the outer tube and inner tube take place. Cleaning between the individual processing steps can therefore be omitted. Apart from transport within the closed device, there is no transport from one processing location to another or storage. This considerably reduces the number of manufacturing and processing steps, shortening the production period. The method according to the invention runs automatically, so that there are no manual processing steps.

According to an advantageous embodiment of the method according to the invention, an outer tube and an inner tube are inserted into the first and second vacuum unit immediately after their production. They thereby go into the vacuum of the first and second vacuum unit immediately after the glass is drawn. Advantageously the temperature does not fall below a prescribed limit value. The consequence is that impurities are not present or at any rate are present only in traces on the surfaces of the outer tube and inner tube.

According to a further advantageous embodiment of the method according to the invention, an outer tube is cleaned after being inserted into the first vacuum unit. To that end, the first vacuum unit is configured with a first cleaning device. If the first vacuum unit is configured with a lock for the insertion of an outer tube, the cleaning device can be arranged on the lock. Such a cleaning of an outer tube is necessary if the outer tube is contaminated due to storage or transport before being inserted into the first vacuum unit.

According to a further advantageous embodiment of the method according to the invention, an inner tube is cleaned after being inserted into the second vacuum unit. To that end, the second vacuum unit is configured with a second cleaning device. If the second vacuum unit is configured with a lock for the insertion of an inner tube, the cleaning device can be arranged on the lock. Such a cleaning of an inner tube is necessary if the inner tube is contaminated due to storage or transport before being inserted into the second vacuum unit.

According to a further advantageous embodiment of the method according to the invention, in the first vacuum unit an inner coating is applied to the inner side of the outer tube. The coating is preferably an antireflective coating that has a low absorptance and a low reflectance.

According to a further advantageous embodiment of the method according to the invention, in the first vacuum unit an outer coating is applied to the outer side of the outer tube. This is preferably an antireflective coating with a low absorptance and a low reflectance.

According to a further advantageous embodiment of the method, in the second vacuum unit a mirror layer is applied to the outer side of the inner tube.

According to a further advantageous embodiment of the method, in the second vacuum unit an absorber layer is applied to the outer side of the inner tube.

According to a further advantageous embodiment of the invention, a base is formed on the outer tube in the first vacuum unit. One end of the outer tube is thus sealed by a base. The outer tube thereby takes on the appearance of a test tube. The base is preferably formed before a coating is applied. Outer tubes with a base at one end serve the production of vacuum tubes closed at one end.

According to a further advantageous embodiment of the invention, a base is formed on the inner tube in the second vacuum unit. One end of the inner tube is thus sealed by a base. Such an inner tube is preferably inserted in a corresponding outer tube which is likewise configured with a base at one end. Outer tubes and inner tubes with a base at one end serve the production of vacuum tubes closed at one end. The base on an inner tube is preferably formed before a coating is applied.

If a base is formed on the outer tube and on the inner tube in the method according to the invention, in the third vacuum unit the gap between the outer tube and inner tube must only be closed at one end of the two tubes.

According to a further advantageous embodiment of the method according to the invention, in the first vacuum unit the outer tube is conveyed in a longitudinal direction relative to the longitudinal axis of the outer tube.

According to a further advantageous embodiment of the method according to the invention, in the second vacuum unit the inner tube is conveyed in a longitudinal direction relative to the longitudinal axis of the inner tube.

According to a further advantageous embodiment of the method according to the invention, the conveying directions of the outer tube and inner tube are parallel to each other.

According to a further advantageous embodiment of the method according to the invention, the outer tube and/or the inner tube are conveyed into the third vacuum unit in a longitudinal direction relative to their longitudinal axis.

According to a further advantageous embodiment of the method according to the invention, when being inserted into the third vacuum unit an inner tube is introduced into an outer tube.

According to a further advantageous embodiment of the method according to the invention, a plurality of outer tubes is arranged in a revolver-type magazine in the third vacuum unit. The magazine is rotated around an axis that is parallel to the conveying direction of the outer tube in the first vacuum unit and/or parallel to the conveying direction of the inner tube in the second vacuum unit.

According to a further advantageous embodiment of the method according to the invention, the coating on the outer tube and/or the coating on the inner tube is applied by means of a plasma process.

According to a further advantageous embodiment of the method according to the invention, the outer tube in the first vacuum unit and/or the inner tube in the second vacuum unit are conveyed by means of rollers or by means of a linear unit.

According to a further advantageous embodiment of the method according to the invention, a centring element for the inner tube is inserted into the outer tube.

According to an advantageous embodiment of the device according to the invention, the first vacuum unit and/or the second vacuum unit and/or the third vacuum unit each comprise at least one vacuum chamber. The vacuum chambers are linked together in such a way that an outer tube or an inner tube can be conveyed from one vacuum chamber to the next without being exposed to the atmosphere. Since a different pressure can prevail in the individual vacuum chambers, gate valves are advantageously provided between the vacuum chambers. If the pressure between two vacuum chambers is very different, a lock can also be provided.

According to a further advantageous embodiment of the device according to the invention, the first vacuum unit is configured with a first vacuum chamber which in turn is configured with a first coating station. The first coating station applies a coating to an inner side of an outer tube. Furthermore, the first vacuum unit is configured with a second vacuum chamber having a second coating station which applies a coating to the outer side of an outer tube.

According to a further advantageous embodiment of the device according to the invention, the second vacuum unit is configured with a third vacuum chamber having a third coating station which applies as coating a mirror layer on the outer side of the inner tube. Furthermore, the second vacuum unit is configured with a fourth vacuum chamber having a fourth coating station which applies as coating an absorber layer to the outer side of the inner tube.

According to a further advantageous embodiment of the device according to the invention, the first coating station and/or the second coating station and/or the third coating station and/or the fourth coating station comprise plasma coating devices.

According to a further advantageous embodiment of the device according to the invention, the magazine of the third vacuum unit is rotatable around an axis.

Further advantages and advantageous embodiments of the invention can be obtained from the following description, the drawing and the claims.

### DRAWING

The drawing shows a model embodiment of a device according to the invention. Illustrations:

FIG. 1 Device for producing vacuum tubes for solar thermal installations

FIG. 2 Device according to FIG. 1 with outer tubes and inner tubes

FIG. 3 Schematic representation of the device according to FIG. 1

### DESCRIPTION OF THE MODEL EMBODIMENT

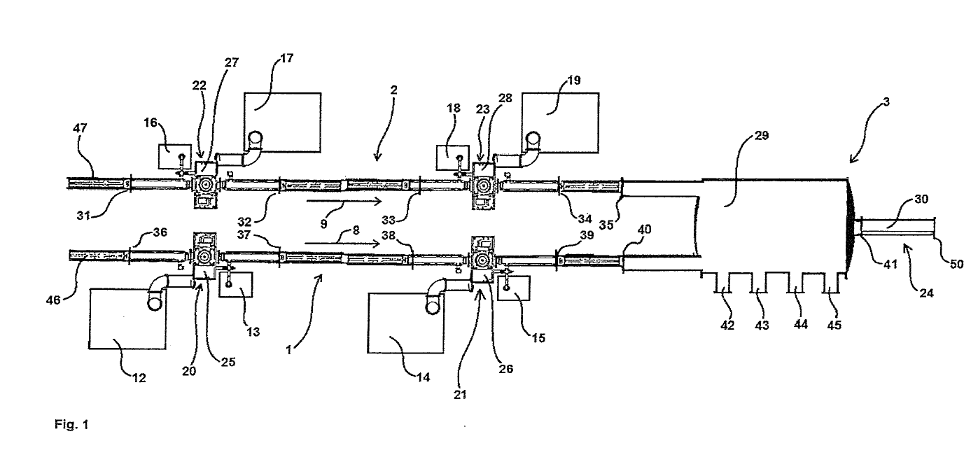

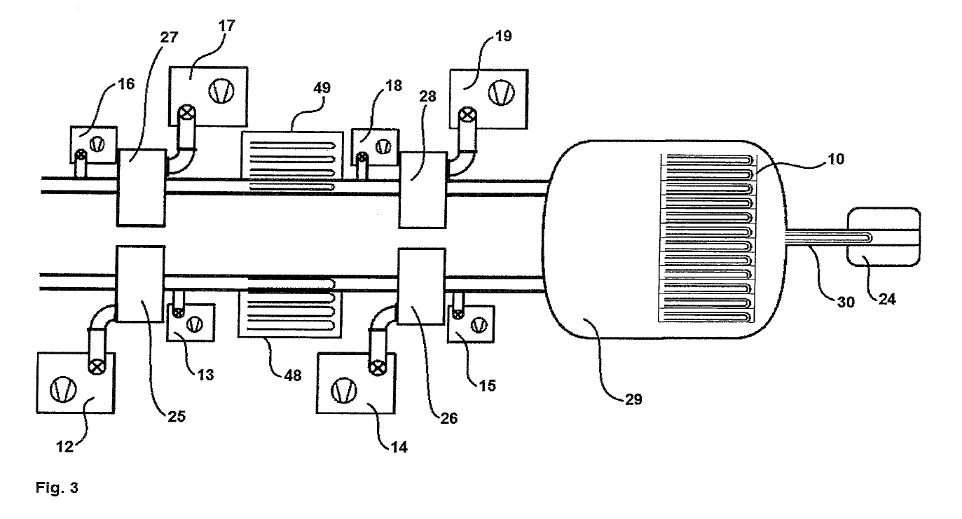

FIGS. 1 to 3 show a model embodiment of a device for producing vacuum tubes for solar thermal installations. The device is shown in a view from the side, whereby the individual components are presented in a longitudinal section. The device comprises a first vacuum unit 1, a second vacuum unit 2 and a third vacuum unit 3. In the first vacuum unit outer tubes 4 are coated. In the second vacuum unit outer tubes 5 are coated. The outer tubes 4 are oblong cylindrical hollow bodies with a circular cross-section and a base 6. They consist of glass. The base 6 can be formed on the outer tube 4 in a first section of the first vacuum unit 1. The inner tubes 5 are oblong cylindrical hollow bodies with a circular cross-section and a base 7. The diameter of the inner tubes 5 is smaller than the diameter of the outer tubes 4. In particular, the outer diameter of the inner tubes 5 is smaller than the inner diameter of the outer tubes 4. The inner tubes likewise consist of glass. The base 7 can be formed on the inner tube 5 in a first section of the second vacuum unit 2. The forming of the bases 6, 7 on the outer tubes 4 and the inner tubes 5 is not shown in the drawing.

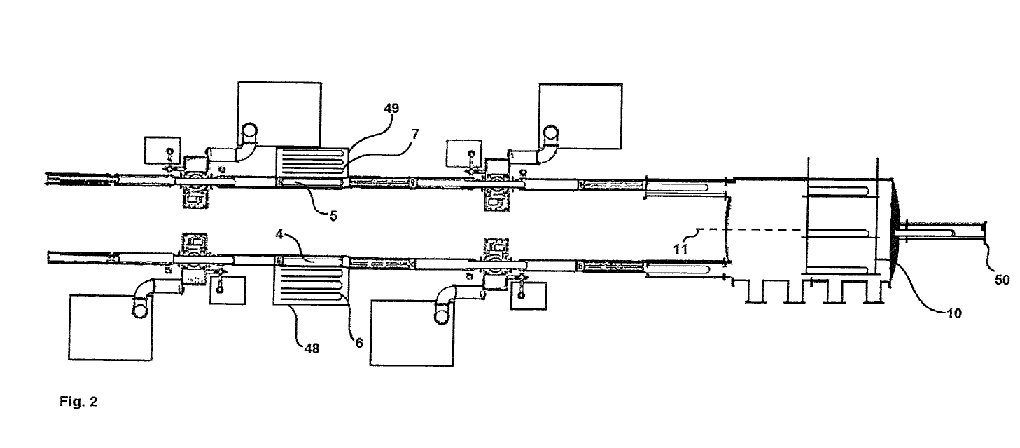

The outer tubes 4 are conveyed in the first vacuum unit 1 by means of a conveying device not shown. The conveying direction is represented by the arrow 8 in FIG. 1. The inner tubes 5 are conveyed in the second vacuum unit 2 by means of a conveying device not shown. The conveying direction is represented by an arrow 9 in FIG. 1. The third vacuum unit 3 comprises a magazine 10 shown in FIG. 2 on which an axis 11 is rotatable. The magazine can accommodate several outer tubes 4 and inner tubes 5.

The first vacuum unit 1 is configured with several vacuum pumps 12, 13, 14, 15. They reduce the gas density in the closed chamber of the first vacuum unit, thereby lowering the pressure and so serving the generation and maintenance of the vacuum in the first vacuum unit 1. The second vacuum unit 2 is likewise configured with several vacuum pumps 16, 17, 18, 19, that serve the same purpose. For the third vacuum unit 3 FIGS. 1 and 2 show only the pump connecting pieces 42, 43, 44, 45 to which the vacuum pumps for generating and maintaining the vacuum and not shown in the drawing are connected.

The first vacuum unit 1 is configured with a first coating station 20 and a first vacuum chamber 25. The vacuum pump 12 is connected to the first vacuum chamber 25. The first vacuum chamber 25 is a part of the first coating station 20. The coating device not visible in the drawing is a plasma device for applying an inner coating to the inner side of an outer tube, in particular an antireflective layer. The first vacuum chamber 25 is connected to a second vacuum chamber 26 and a second coating station 21 by means of a vacuum transfer section. The vacuum pump 13 is connected to the vacuum transfer section. The vacuum pump 14 is connected to the second vacuum chamber 26. The second coating station 21 and the second vacuum chamber 26 are likewise part of the first vacuum unit 1. The coating device not visible in the drawing of the second coating station 21 is a plasma device for applying an outer coating to the outer side of an outer tube. The second vacuum chamber 26 is connected to the third vacuum unit 3 by means of a further vacuum transfer section. The vacuum pump 15 is connected to this vacuum transfer section.

The second vacuum unit 2 is configured with a third coating station 22 and a third vacuum chamber 27. The vacuum pump 17 is connected to the third vacuum chamber 27. The third vacuum chamber 27 is a part of the third coating station 22. The coating device not visible in the drawing is a plasma device for applying a mirror layer to the outer side of an inner tube. The third vacuum chamber 27 is connected to a fourth vacuum chamber 28 and a fourth coating station 23 by means of a vacuum transfer section. The vacuum pump 18 is connected to the vacuum transfer section. The fourth coating station 23 and the fourth vacuum chamber 28 are likewise part of the second vacuum unit 2. The coating device not visible in the drawing of the fourth coating station 23 is a plasma device for applying an outer coating to the outer side of an inner tube, in particular an absorber layer. The vacuum pump 19 is connected to the fourth vacuum chamber 28. The fourth vacuum chamber 28 is connected to the third vacuum unit 3 by means of a further vacuum transfer section.

The third vacuum unit 3 comprises a fifth vacuum chamber 29 in which the magazine 10 is arranged. The fifth vacuum chamber 29 is configured with a tempering device not shown in the drawing. The third vacuum unit 3 further has a sixth vacuum chamber 30 that is configured with a fusing device 24. In this fusing device 24 an outer tube is fused with an inner tube such that the gap between the outer tube and inner tube is sealed.

The individual sections of the first, second and third vacuum unit 1, 2, 3 are configured with gate valves. These gate valves can be opened and closed in order to isolate individual sections of the vacuum units as required. A first gate valve 31 is arranged before the third vacuum chamber 27. A second gate valve 32 is arranged after the third vacuum chamber. The gate valves 31, 32 are opened so that an inner tube can pass. The gate valves 31, 32 are closed if an inner tube is being coated in the third vacuum chamber in order that the vacuum in the transfer sections before and after the third vacuum chamber 27 is not impaired through the coating process and the coating material. The gate valves 33 and 34 are analogously arranged at the third vacuum chamber 28, gate valves 36, 37 at the first vacuum chamber 25 and gate valves 38, 39 at the second vacuum chamber 26. A gate valve 40 is arranged at the transition between the first vacuum unit 1 and the third vacuum unit 3. A gate valve 35 is arranged at the transition between the second vacuum unit 2 and the third vacuum unit 3. A gate valve 41 is arranged between the fifth vacuum chamber 29 and the sixth vacuum chamber 30. On its end away from the fifth vacuum chamber the sixth vacuum chamber is further configured with a gate valve 50. Through this gate valve a finished vacuum tube is discharged from the device.

The first vacuum unit 1 is configured with lock 46 at its front end relative to the conveying direction 8 of the outer tubes. Through this lock 46 an outer tube is inserted into the device. The lock can be configured with a cleaning unit not shown in the drawing. The lock 46 can further be configured with a device not shown in the drawing for forming a base 6 on an outer tube. The lock comprises a vacuum pump that is likewise not shown in the drawing.

The second vacuum unit 2 is configured with lock 47 at its front end relative to the conveying direction 9 of the inner tubes. Through this lock 47 an inner tube is inserted into the device. The lock can be configured with a cleaning unit not shown in the drawing. The lock 47 can further be configured with a device not shown in the drawing for forming a base 7 on an inner tube. The lock comprises a vacuum pump that is likewise not shown in the drawing.

At the transfer section between the first and the second vacuum chamber 25, 26 of the first vacuum unit 1 is arranged a holder 48 shown in FIG. 2 in which outer tubes can be stored temporarily after their coating in the first coating station 20 and before their coating in the second coating station 21. The holder is part of the first vacuum unit 1. A vacuum prevails in the holder 48. The holder can serve as a buffer between the first and the second coating station. The coating processes in the first and the second coating station 20, 21 can have different durations.

At the transfer section between the third and the fourth vacuum chamber 27, 28 of the second vacuum unit 2 is arranged a holder 49 shown in FIG. 2 in which inner tubes can be stored temporarily after their coating in the third coating station 22 and before their coating in the fourth coating station 23. The holder is part of the second vacuum unit 2. A vacuum prevails in the holder 49. The holder can serve as a buffer between the third and the fourth coating station. The coating processes in the third and the fourth coating station 22, 23 can have different durations.

The method for producing vacuum tubes that is performed with the device according to FIGS. 1 to 3 proceeds as follows:

An outer tube 4 is inserted through lock 46 into the first vacuum unit 1 of the device. A base 6 is then formed on the outer tube. The outer tube 4 is conveyed to the first vacuum chamber 25 having the first coating station 20 by means of a conveying device not shown in the drawing. The gate valve 36 is opened so that the outer tube 4 can be moved into the first vacuum chamber 25. When the outer tube is located in the first vacuum chamber 25, the gate valve 36 is closed. The gate valve 37 is already closed. In the first vacuum chamber 25 the outer tube is coated on its inner side. After the end of the coating process the gate valve 37 is opened. The coated outer tube is moved out of the first vacuum chamber. The gate valve 37 is then closed again. The outer tube reaches the second coating station 21 having the second vacuum chamber 26 through a vacuum transfer section having a conveying device not shown in the drawing. The outer tube provided with a coating on its inner side is stored temporarily in the holder 48 as the case may be. To ensure that the outer tube can be conveyed into the second vacuum chamber, the gate valve 38 is opened. After the outer tube 4 is received in the second vacuum chamber 26, the gate valve 38 is closed. The gate valve 39 is already closed. In the second vacuum chamber 26 having the second coating station 21 the outer tube is coated on its outer side. After the end of the coating process the gate valve 39 opens so that the coated outer tube 4 can leave the second vacuum chamber 26. The coated outer tube 4 reaches the third vacuum unit 3 through a vacuum transfer section. To that end the gate valve 40 is opened so that the outer tube can pass. In the fifth vacuum chamber 29 the coated outer tube is deposited in the magazine 10.

Simultaneously with the coating of an outer tube, an inner tube 5 is coated in the second vacuum chamber 2. Outer tube and inner tube are processed in parallel. An inner tube 5 is inserted through lock 47 into the second vacuum unit 2 of the device. A base 7 is then formed on the inner tube. The inner tube 5 is conveyed to the third vacuum chamber 27 having the third coating station 22 by means of a conveying device not shown in the drawing. The gate valve 31 is opened so that the inner tube 5 can be moved into the third vacuum chamber 27. When the inner tube is located in the third vacuum chamber 27, the gate valve 31 is closed. The gate valve 32 is already closed. In the third vacuum chamber 27 the inner tube is coated on its outer side. A mirror layer is applied. After the end of the coating process the gate valve 32 is opened. The coated inner tube is moved out of the third vacuum chamber 27. The gate valve 32 is then closed again. The inner tube reaches the fourth coating station 23 having the fourth vacuum chamber 28 through a vacuum transfer section having a conveying device not shown in the drawing. The inner tube provided with a coating on its outer side is stored temporarily in the holder 49 as the case may be. To ensure that the inner tube can be conveyed into the fourth vacuum chamber, the gate valve 33 is opened. After the inner tube 5 is received in the fourth vacuum chamber 28, the gate valve 33 is closed. The gate valve 34 is already closed. In the fourth vacuum chamber 28 having the fourth coating station 23 the inner tube is again coated on its outer side. An absorber layer is applied. After the end of the coating process the gate valve 34 opens so that the coated inner tube 5 can leave the fourth vacuum chamber 28. The coated inner tube 5 reaches the third vacuum unit 3 through a vacuum transfer section. To that end, the gate valve 35 is opened so that the inner tube can pass. In the fifth vacuum chamber 29 the coated inner tube is moved to the magazine 10 and inserted into an outer tube already deposited there. In the third vacuum unit a getter not shown in the drawing can be inserted into an outer tube.

From the fifth vacuum chamber 29 an outer tube with an inner tube arranged therein is conveyed into the sixth vacuum chamber 30. There the outer tube and the inner tube are fused together at their open ends. The gap between the outer tube and the inner tube is thereby sealed. Since the process takes place in a vacuum, a vacuum likewise prevails in the sealed gap between the outer tube and the inner tube. After the fusing the outer tube with the inner tube arranged therein is conveyed back into the fifth vacuum chamber, deposited in the magazine 10 and tempered. After the end of the tempering process the production of the vacuum tubes is completed. The finished vacuum tube is conveyed away through the opened gate valve 50.

The coating of outer tubes in the first vacuum unit 1 takes place continuously. The outer tubes are inserted into the first vacuum unit 1 one after the other. As soon as the coating of an outer tube in the first coating station 20 is completed, for instance, the correspondingly coated outer tube is conveyed away from the first vacuum chamber 25 and the next outer tube is received in the first coating station 20. This applies analogously for the second coating station 21. The coating of the inner tubes in the second vacuum unit also takes place in this manner.

All features can be material to the invention both individually and in any combination.

### REFERENCE NUMBERS

1 First vacuum unit
2 Second vacuum unit
3 Third vacuum unit
4 Outer tube
5 Inner tube
6 Base of the outer tube
7 Base of the inner tube
8 Conveying direction of an outer tube
9 Conveying direction of an inner tube
10 Magazine
11 Axis of the magazine
12 Vacuum pump
13 Vacuum pump
14 Vacuum pump
15 Vacuum pump
16 Vacuum pump
17 Vacuum pump
18 Vacuum pump
19 Vacuum pump
20 First coating station
21 Second coating station
22 Third coating station
23 Fourth coating station
24 Fusing device
25 First vacuum chamber
26 Second vacuum chamber
27 Third vacuum chamber
28 Fourth vacuum chamber
29 Fifth vacuum chamber
30 Sixth vacuum chamber
31 Gate valve
32 Gate valve
33 Gate valve
34 Gate valve
35 Gate valve
36 Gate valve
37 Gate valve
38 Gate valve
39 Gate valve
40 Gate valve
41 Gate valve
42 Pump connecting piece
43 Pump connecting piece
44 Pump connecting piece
45 Pump connecting piece
46 Lock
47 Lock
48 Holder
49 Holder
50 Gate valve

1. Method for producing vacuum tubes for solar thermal installations, whereby the vacuum tube comprises an outer tube and an inner tube arranged within the outer tube and the gap between the outer tube and the inner tube is sealed with respect to the exterior and evacuated, comprising the following method steps:
insertion of an outer tube (4) into a first vacuum unit (1), in which a vacuum prevails,
application of at least one coating on the outer side and/or the inner side of the outer tube (4) in the first vacuum unit (1), insertion of an inner tube (5) into a second vacuum unit (5), in which a vacuum prevails,
application of at least one coating on the outer side and/or the inner side of the inner tube (5) in the second vacuum unit (2), insertion of the coated outer tube (4) into a third vacuum unit (3) linked to the first and the second vacuum unit (1, 2), whereby the coated outer tube (4) is conveyed directly from the first vacuum unit (1) into the third vacuum unit (3),
insertion of the coated inner tube (5) into the third vacuum unit (3), whereby the coated inner tube (5) is conveyed directly from the second vacuum unit (2) into the third vacuum unit (3), insertion of the inner tube (5) into the outer tube (4) in the third vacuum unit (3),
fusing of the open ends of the coated outer tube (4) and the coated inner tube (5), whereby a vacuum prevails in the gap between the outer tube (4) and the inner tube (5),
tempering of the outer tube (4) and the inner tube after and/or before the fusing in the third vacuum unit.

2. Method according to claim 1, wherein a base (6) is formed on the outer tube (4) in the first vacuum unit (1).

3. Method according to claim 1, wherein a base (7) is formed on the inner tube (5) in the second vacuum unit (2).

4. Method according to claim 1, wherein the outer tube (4) in the first vacuum unit (1) is conveyed in the longitudinal direction relative to the longitudinal axis of the outer tube (4).

5. Method according to claim 1, wherein the inner tube (5) in the second vacuum unit (2) is conveyed in the longitudinal direction relative to the longitudinal axis of the inner tube (5).

6. Method according to claim 1, wherein the conveying direction (8) of the outer tube (4) and the conveying direction (9) of the inner tube (5) are parallel to each other.

7. Method according to claim 1, wherein the outer tube (4) and/or the inner tube (5) are conveyed into the third vacuum unit (3) in the longitudinal direction relative to their longitudinal axis.

8. Method according to claim 1, wherein several outer tubes (4) are arranged in a magazine (10) in the third vacuum unit (3).

9. Method according to claim 1, wherein the coating is applied to the outer tube (4) and/or the coating is applied to the inner tube (5) by means of a plasma process.

10. Method according to claim 1, wherein the outer tube (4) in the first vacuum unit (1) and/or the inner tube (5) in the second vacuum unit (2) are conveyed by means of rollers or by means of a linear unit.

11. Device for producing vacuum tubes for solar thermal installations, whereby the vacuum tube comprises an outer tube and an inner tube arranged within the outer tube and the gap between the outer tube and the inner tube is sealed with respect to the exterior and evacuated, in particular for the performance of the method according to claim 1,
with a first vacuum unit (1) defining a sealable space,
with one or more vacuum pumps (12, 13, 14, 15) of the first vacuum unit (1) which evacuate the first vacuum unit (1),
with a first conveying device which conveys an outer tube (4) in the first vacuum unit (1) in a longitudinal direction,
with at least one coating station (20, 21) applying a coating to the outer tube (4) at the first vacuum unit (1),
with a second vacuum unit (2) defining a sealable space,
with at least one vacuum pump (16, 17, 18, 19) which evacuates the second vacuum unit (2),
with a second conveying device which conveys an inner tube (5) in the second vacuum unit (2) in a longitudinal direction,
with at least one coating station (22, 23) applying a coating on the inner tube (5) at the second vacuum unit (2),
with a third vacuum unit (3) that is linked to the first and to the second vacuum unit (1, 2) and defines a sealable space,
with a movable magazine (10) of the third vacuum unit (3) in which several outer tubes (4) and/or inner tubes (5) are stored and tempered,
with a fusing device (24) of the third vacuum unit (3) which fuses together the ends of an inner tube (5) and an outer tube (4).

12. Device according to claim 11, wherein the first vacuum unit (1) and/or the second vacuum unit (2) and/or the third vacuum unit (3) each comprise at least one vacuum chamber (25, 26, 27, 28, 29, 30).

13. Device according to claim 12, wherein the first vacuum unit (1) is configured with a first vacuum chamber (25) having a first coating station (20) which applies a coating on the inner side of an outer tube (4) and wherein the first vacuum unit (1) is configured with a second vacuum chamber (26) having a second coating station (21) which applies a coating to the outer side of an outer tube (4).

14. Device according to claim 11, wherein the second vacuum unit (2) is configured with a third vacuum chamber (27) having a third coating station (22) which applies a mirror layer as coating on the outer side of the inner tube (5) and wherein the second vacuum unit (2) is configured with a fourth vacuum chamber (28) having a fourth coating station (23) which applies an absorber layer as coating on the outer side of the inner tube (5).

15. Device according to claim 11, wherein the first coating station (20) and/or the second coating station (21) and/or the third coating station (22) and/or the fourth coating station (23) comprise plasma coating devices.
